(19) United States
(12) Patent Application Publication
(10) Pub. No.: US 2008/0286007 A1
(43) Pub. Date: Nov. 20, 2008

(54) IMAGE FORMING APPARATUS AND IMAGE FORMING METHOD

(75) Inventors: Ji-won JEONG, Suwon-si (KR); Cheol-ho JEONG, Suwon-si (KR); Sung-kyu CHOI, Bucheon-si (KR); Seung-ran PARK, Suwon-si (KR); Jung-woo KIM, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/029,698

(22) Filed: Feb. 12, 2008

(30) Foreign Application Priority Data
May 18, 2007 (KR) 10-2007-0048731

(51) Int. Cl. G03G 15/00

(52) U.S. Cl. 399/130; 399/159

(57) ABSTRACT

An image forming apparatus and an image forming method are provided, in which a drum itself forms an electrostatic latent image corresponding to print data that is to be printed, on a surface of the drum, the electrostatic latent image is developed so as to generate a developed image, the developed image is transferred onto a printing medium, and the transferred image is fixed to the printing medium. Accordingly, the time required to print the print data is drastically reduced, it is possible to reduce the size of an image forming apparatus, and high quality print outs can be obtained.

### CROSS-REFERENCE TO RELATED PATENT APPLICATION

This application claims priority from Korean Patent Application No. 10-2007-0048731, filed on May 18, 2007, in the Korean Intellectual Property Office, the disclosure of which is incorporated herein in its entirety by reference.

### BACKGROUND OF THE INVENTION

1. Field of the Invention

The present invention relates to printing, and more particularly to an image forming apparatus and an image forming method in which prints are produced by forming an electrostatic latent image on a drum, developing the electrostatic latent image to create a developed image, transferring the developed image onto a printing medium, and fixing the transferred image onto the printing medium.

2. Description of the Related Art

Conventional image forming apparatuses create print outs by performing different exposing processes, based on data that is to be printed, with respect to a drum surface uniformly charged with a certain polarity to form an electrostatic latent image on the drum surface, developing the electrostatic latent image using a developer such as a toner to form a developed image, transferring the developed image onto a printing medium, and fixing the transferred image onto the printing medium.

As such, conventional image forming apparatuses must perform the operation of uniformly charging the entire drum surface and the operation of exposing the drum surface in order to create print outs, and as such there is a limit in reducing the time required for the conventional image forming apparatuses to print data.

Furthermore, conventional image forming apparatuses necessarily include a device for uniformly charging the entire surface of a drum with charges of a certain polarity and a device for exposing the drum surface, and as such there is also a limit in reducing the sizes of image forming apparatus products. Therefore, conventional image forming apparatuses fail to match recent trends in which small products hold a dominant position in the market.

### SUMMARY OF EXEMPLARY EMBODIMENTS OF THE INVENTION

An exemplary embodiment of the present invention provides an image forming apparatus which prints data without performing uniform charging over the entire surface of a drum with charges of a certain polarity and without performing exposure with respect to the drum surface.

Another exemplary embodiment of the present invention also provides an image forming method in which data is printed without performing uniform charging over the entire surface of a drum with charges of a certain polarity and performing exposure with respect to the drum surface.

Yet another exemplary embodiment of the present invention also provides a computer readable recording medium having stored thereon a computer program for an image forming method in which data is printed without performing uniform charging over the entire surface of a drum with charges of a certain polarity and performing exposure with respect to the drum surface.

According to an aspect of the present invention, there is provided an image forming apparatus including a drum itself forming an electrostatic latent image corresponding to print data that is to be printed, on a surface of the drum, a developing unit developing the electrostatic latent image so as to generate a developed image, a transfer unit transferring the developed image onto a printing medium, and a fixing unit fixing the transferred image to the printing medium.

According to another aspect of the present invention, there is provided an image forming method performed in an image forming apparatus including a drum, the method including the operations of: forming an electrostatic latent image corresponding to print data that is to be printed, on a surface of the drum; developing the electrostatic latent image so as to generate a developed image; transferring the developed image onto a printing medium; and fixing the transferred image to the printing medium, wherein the operation of forming the electrostatic latent image is performed by the drum itself.

According to another aspect of the present invention, there is provided a computer readable medium having embodied thereon a computer program for an image forming method performed in an image forming apparatus including a drum, the method including the operations of: forming an electrostatic latent image corresponding to print data that is to be printed, on a surface of the drum; developing the electrostatic latent image so as to generate a developed image; transferring the developed image onto a printing medium; and fixing the transferred image to the printing medium, wherein the operation of forming the electrostatic latent image is performed by the drum itself.

### BRIEF DESCRIPTION OF THE DRAWINGS

The above and other aspects of the present invention will become more apparent by describing in detail exemplary embodiments thereof with reference to the attached drawings in which:

FIG. 1A is a block diagram of an image forming apparatus according to an exemplary embodiment of the present invention;

FIG. 1B is a perspective view of a structure of the image forming apparatus illustrated in FIG. 1A;

FIG. 2 is a reference diagram for explaining cells that constitute a circumference of a drum illustrated in FIG. 1B and an electrostatic latent image forming unit illustrated in FIG. 1A; and

FIG. 3 is a flowchart of an image forming method according to an embodiment of the present invention.

### DETAILED DESCRIPTION OF EXEMPLARY EMBODIMENTS OF THE INVENTION

The attached drawings for illustrating exemplary embodiments of the present invention are referred to in order to gain a sufficient understanding of the present invention.

Hereinafter, the present invention will be described in detail by explaining exemplary embodiments of the invention with reference to the attached drawings. Like reference numerals in the drawings denote like elements.

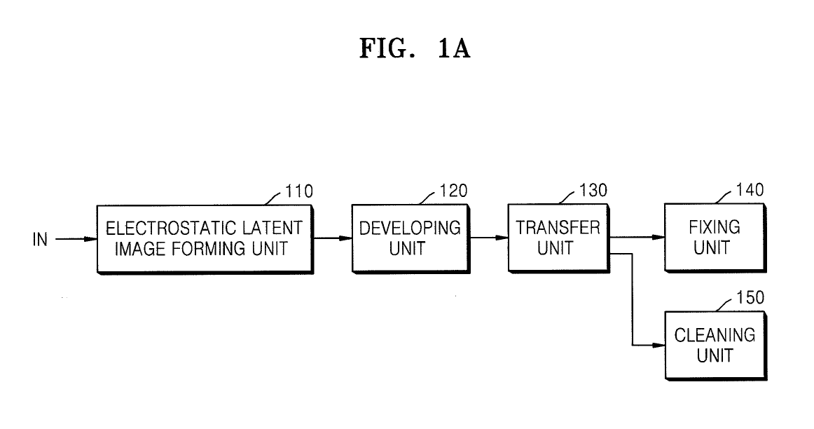

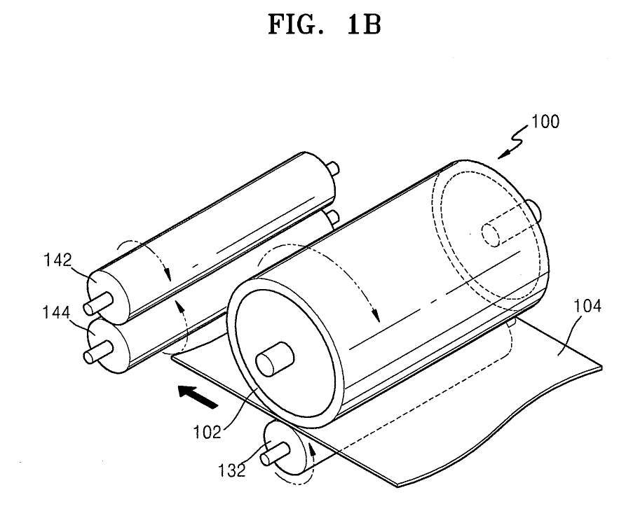

FIG. 1A is a block diagram of an image forming apparatus according to an exemplary embodiment of the present invention, which includes an electrostatic latent image forming unit 110, a developing unit 120, a transfer unit 130, a fixing unit 140, and a cleaning unit 150. FIG. 1B is a perspective view of a structure of the image forming apparatus illustrated in FIG. 1A.

The image forming apparatus in this specification denotes an apparatus having a printing function, such as, a printer or a multifunction peripheral (MFP) having a printing function.

Referring to FIGS. 1A and 1B, the image forming apparatus has a drum 100, which is different from a drum, known as a photoconductive drum, included in a conventional image forming apparatus. More specifically, the circumference 102 of the drum 100 is made up of a plurality of cells. The entire area of the circumference 102 is preferably divided into the plurality of cells. In other words, each cell corresponds to a basic unit of the components of the circumference 102 of the drum 100. Hereinafter, for convenience of explanation, it is assumed that the circumference 102 of the drum 100 is implemented as a plurality of cells arranged in a matrix. In exemplary embodiments of the present invention, the element “the circumference” 102 of the drum 100 denotes not only the surface of the drum 100 but also includes a space between the surface of the drum 100 and a specific distance inwards from the surface of the drum 100 towards the center of the drum 100. Here, the value of the specific distance inwards from the surface of the drum 100 may vary.

The drum 100 may have a variety of shapes. In other words, the drum 100 may be a cylindrical drum as shown in FIG. 1B or a belt-shaped drum in contrast to FIG. 1B.

The electrostatic latent image forming unit 110 is implemented as the drum 100, which itself forms at least one electrostatic latent image corresponding to print data input via an input port IN on the surface thereof. The print data input via the input port IN denotes data that the image forming apparatus desires to print, and also denotes data that can be printed.

More specifically, the drum 100 charges the cells of the circumference 102 in consideration of the print data that the image forming apparatus desires to print, thereby forming the at least one electrostatic latent image corresponding to the print data on the surface thereof. To be further specific, the drum 100 forms the at least one electrostatic latent image corresponding to the print data on the surface thereof by updating the electrical characteristics (for example, a polarity and a charge amount) of one surface of each of the cells, the one surface corresponding to a part of the surface of the drum 100, in consideration of the print data. For example, the drum 100 may form at least one electrostatic latent image on the surface thereof by charging a surface corresponding to the electrostatic latent image among the surfaces of the cells that correspond to parts of the surface of the drum 100 with charges of Q (which is a positive number) [Coulomb]. At this time, surfaces other than the surface corresponding to the electrostatic latent image may be charged with charges of 0 [Coulomb] or P (which is a negative number) [Coulomb].

The drum 100 operates in consideration of the size (for example, A4 or B5) of a printing medium 104, on which the print data is to be printed. More specifically, the drum 100 recognizes only cells that are to contact the printing medium 104 during transfer among the cells of the circumference 102 of the drum 100, and charges only the recognized cells in consideration of the print data to thereby form the at least one electrostatic latent image. The printing medium 104 denotes a medium on which an image is to be printed. The printing medium 104 may be formed of various materials, such as, an overhead projector (OHP) film. The size of the printing medium 104 may denote the area of the printing medium 104.

The drum 100 also operates in consideration of a printing resolution (for example, 1200 dpi (dot per inch)) set for the print data that the image forming apparatus desires to print. For example, whether the surfaces of the cells that correspond to parts of the surface of the drum 100 are charged with charges of Q [Coulomb] or with charges of 0 [Coulomb] or P [Coulomb] is determined according to a printing resolution set for the print data input via the input port IN even when the input print data is identical.

The developing unit 120 generates a developed image by developing the electrostatic latent image formed by the electrostatic latent image forming unit 110 using a developer. In other words, the developed image denotes a result of the developing of the electrostatic latent image. The developer may be toner and preferably has a certain polarity (for example, a negative polarity).

The transfer unit 130 transfers the at least one electrostatic latent image generated by the developing unit 130 onto the printing medium 104. The transfer unit 130 may be implemented as a transfer roller 132. In this case, the at least one electrostatic latent image existing on the surface of the drum 100 is transferred onto the printing medium 104 by an engagement of the transfer roller 132 with the drum 100. Rotations of the drum 100 and the transfer roller 132 may be clockwise and counterclockwise, respectively, as shown in FIG. 1B, or may be counterclockwise and clockwise, respectively, in contrast to FIG. 1B.

The developed image existing on the surface of the drum 100 is transferred onto the printing medium 104 wherein a portion of the surface of the drum 100, on which the developed image is located, is charged to correspond to the polarity of the developed image. More specifically, immediately before at least one particle of the developer attached to one surface of each cell, which is a part of the surface of the drum 100, is transferred onto the printing medium 104, the one surface can be charged to have a polarity corresponding to the polarity of the developer particle. For example, if the developer particle attached to the one surface of each cell has a negative polarity, the polarity of the one surface may be changed from positive to negative immediately before the developer particle attached to the one surface is transferred onto the printing medium 104. In a conventional image forming apparatus, only a transfer roller is charged to transfer a developed image existing on a drum surface. However, in an image forming apparatus according to an exemplary embodiment of the present invention, as illustrated in FIGS. 1A and 1B, the surface of the drum 100 is charged to detach the developed image therefrom, and the transfer roller 132 is also charged to transfer the detached developed image onto the printing medium 104. Consequently, the developed image existing on the surface of the drum 100 according to an exemplary embodiment of the present invention is more easily transferred onto the printing medium 104 than the transfer of the developed image existing on the conventional drum surface.

The fixing unit 140 fixes the at least one electrostatic latent image transferred by the transfer unit 130 to the printing medium 104. More specifically, the fixing unit 140 fixes the developed image transferred onto the printing medium 104 to the printing medium 104 using heat and pressure. To achieve the fixing, the fixing unit 140 may be implemented as a heat roller 142 and a pressure roller 144. The heat roller 142 heats the printing medium 104 fed between the heat roller 142 and the pressure roller 144 that engage with each other. The pressure roller 144 presses the printing medium 104 fed between the heat roller 142 and the pressure roller 144 that engage with each other. Rotations of the heat roller 142 and the pressure roller 144 may be clockwise and counterclockwise, respectively, as shown in FIG. 1B, or may be counterclockwise and clockwise, respectively, in contrast to FIG. 1B.

The cleaning unit 150 starts after an operation of the transfer unit 130 is completed, and removes particles of the developer remaining on the surface of the drum 100. The developer representing the at least one electrostatic latent image existing on the surface of the drum 100 should be entirely transferred onto the printing medium 104. However, in practice, some of the developer may remain on the surface of the drum 100 even after the transfer of the developer. Particles of the developer that remain on the surface of the drum 100 after the transfer unit 130 transfers print data input for an n-th (where n denotes a natural number) time via the input port IN degrade the quality of printing of print data that is input for an (n+1)th time via the input port IN. Therefore, the image forming apparatus of FIGS. 1A and 1B includes the cleaning unit 150 in order to remove the remaining developer particles.

In order to remove the developer particles that remain on the surface of the drum 100 after the completion of the transfer by the transfer unit 130, the cleaning unit 150 may initialize the electrical state of the surface of the drum 100 every time the transfer unit 130 completes the transfer. For example, if the polarity of the developer particles remaining on the surface of the drum 100 after the completion of the transfer by the transfer unit 130 is negative and the default polarity of the surface of the drum 100 is neutral, the polarity of a surface area of the drum 100 on which the developer particles remain after the completion of the transfer by the transfer unit 130 is changed from positive to neutral so that the remaining developer particles are easily detached from the surface of the drum 100. Accordingly, when new print data is given, the image forming apparatus according to an exemplary embodiment of the present invention can easily remove remaining developer particles from the drum surface before starting to print the new print data.

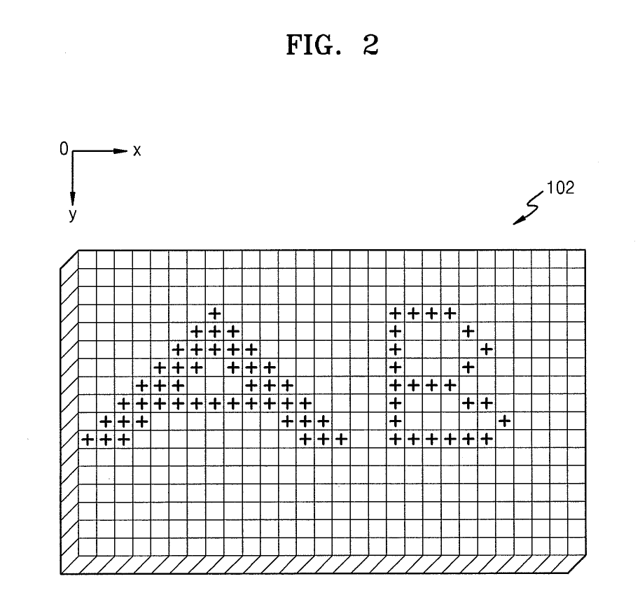

FIG. 2 illustrates an unrolled state of the circumference 102 of the drum 100 for explaining the cells that constitute the circumference 102 of the drum 100 of FIG. 1B and the electrostatic latent image forming unit 110 of FIG. 1A.

As illustrated in FIG. 2, the circumference 102 of the drum 100 may be made up of a plurality of cells that are arranged in a matrix. Referring to FIG. 2, 28 columns of cells exist in a horizontal direction (i.e., an x-axis direction) and 17 rows of cells exist in a vertical direction (i.e., a y-axis direction), such that the circumference 102 of the drum 100 is made up of 476 cells (where 476=28×17).

In this case, the drum 100 forms at least one electrostatic latent image corresponding to print data on a surface thereof by charging the cells, which constitute the circumference 102 of the drum 100, in consideration of the print data. In other words, the drum 100 charges the 476 cells having locations (x, y), namely, (1, 1), (1, 2), (1, 3), (1, 4), . . . , (28, 15), (28, 16), and (28, 17), in consideration of the print data. Here, a location (x, y), being (I, j) (where i is an integer satisfying I≦i≦2, and j is an integer satisfying 1≦j≦17), denotes a location with an i-th coordinate in a horizontal direction and a j-th coordinate in a vertical direction.

As illustrated in FIG. 2, the print data that the image forming apparatus of FIGS. 1A and 1B desires to print is the letters ‘A’ and ‘B’. Accordingly, the drum 100 forms two electrostatic latent images A and B on the surface thereof by charging surfaces corresponding to the electrostatic latent images A and B among the surfaces of the cells corresponding to parts of the surface of the drum 100 with charges of Q [Coulomb]. At this time, surfaces other than the surfaces corresponding to the electrostatic latent images A and B may be charged with charges of 0 [Coulomb] as illustrated in FIG. 2 or with charges of P [Coulomb] in contrast to FIG. 2. When the surfaces other than the surfaces corresponding to the electrostatic latent images A and B are charged with charges of P [Coulomb] instead of 0 [Coulomb], a developer can be more securely prevented from being attached to surface portions of the drum other than the surface portions on which the electrostatic latent images A and B are formed.

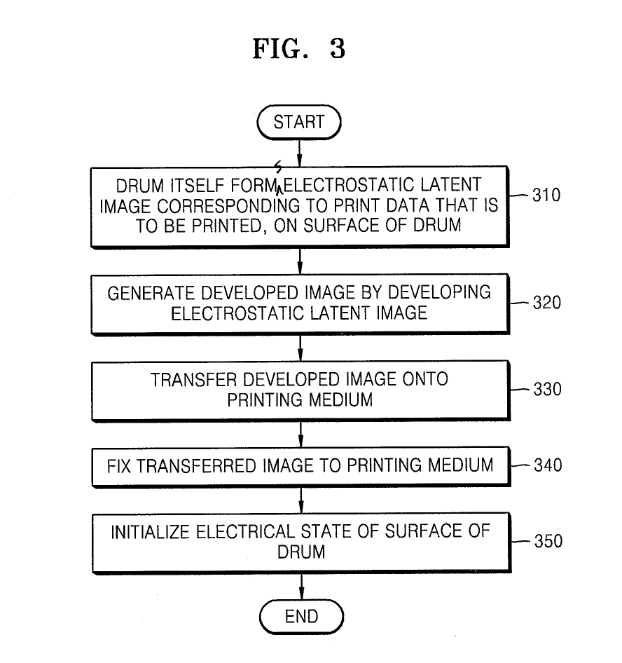

FIG. 3 is a flowchart of an image forming method according to an exemplary embodiment of the present invention performed in the image forming apparatus illustrated in FIGS. 1A and 1B. The image forming method may include operations 310 through 350 for printing data without charging the entire surface of a drum with charges of a certain polarity and without exposing the drum surface.

In operation 310, the drum 100 itself forms at least one electrostatic latent image corresponding to print data, which the image forming apparatus desires to print, on the surface thereof.

After operation 310, in operation 320, the developing unit 120 develops the electrostatic latent image to thereby generate at least one developed image.

After operation 320, in operation 330, the transfer unit 130 transfers the developed image to the printing medium.

After operation 330, in operation 340, the fixing unit 140 fixes the developed image onto the printing medium.

After operation 330 or 340, in operation 350, the cleaning unit 150 initializes the electrical state of the surface of the drum 100.

As described above, in an image forming apparatus and an image forming method according to an exemplary embodiment of the present invention, a drum itself forms an electrostatic latent image on the surface thereof in contrast to the conventional art in which an electrostatic latent image corresponding to print data is formed on the surface of a drum by uniformly charging the entire drum surface with charges of a certain polarity and exposing the drum surface. Therefore, the time required to print the print data is drastically reduced.

In addition, the image forming apparatus includes no devices for uniformly charging the entire drum surface with charges of a certain polarity and no devices for exposing the drum surface, thereby increasing the product competitiveness through miniaturization.

In a conventional image forming method where the uniform charging of the entire drum surface with charges of a certain polarity and the exposure of the drum surface are necessarily performed to print data, if at least one of the uniform charging and the exposure is abnormally performed, high quality print outs cannot be expected. However, in the image forming method according to the present invention, the two operations are not needed, resulting in high quality print outs.

Moreover, in the image forming apparatus and the image forming method according to an exemplary embodiment of the present invention, the polarity of the surface of the drum is changed to easily detach a developed image from the drum surface upon transfer of the developed image onto a printing medium, so that the developed image is more easily transferred onto the printing medium than in the conventional art. Similarly, when new print data is given, developer remainders can be clearly and easily removed from the drum surface before printing the print data, by changing the polarity of the drum surface.

The exemplary embodiments of the present invention can be written as computer programs and can be implemented in general-use digital computers that execute the programs using a computer readable recording medium and other types of transmission media. Examples of the computer readable recording medium include magnetic storage media (e.g., ROM, floppy disks, hard disks, etc.), and optical recording media (e.g., CD-ROMs, or DVDs). Other types of transmission media can include carrier waves (e.g., transmission through the Internet).

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An image forming apparatus comprising:
a drum which forms an electrostatic latent image corresponding to print data that is to be printed, on a surface of the drum;
a developing unit which develops the electrostatic latent image so as to generate a developed image;
a transfer unit which transfers the developed image onto a printing medium; and
a fixing unit which fixes the transferred image to the printing medium.

2. The image forming apparatus of claim 1, wherein the drum forms the electrostatic latent image by, in consideration of the print data, charging each of a plurality of cells which constitute a circumference of the drum.

3. The image forming apparatus of claim 2, wherein the cells are arranged in a matrix.

4. The image forming apparatus of claim 1, wherein at least a portion of the surface of the drum on which the developed image is located is charged in accordance with the polarity of the developed image, and in this state, the developed image is transferred onto the printing medium.

5. The image forming apparatus of claim 1, further comprising a cleaning unit which initializes an electrical state of the surface of the drum every time the transfer unit completes its operation.

6. The image forming apparatus of claim 1, wherein the drum operates at least based on at least one of a printing resolution set for the print data and a size of the printing medium.

7. The image forming apparatus of claim 1, wherein the drum is one of a belt drum and a cylindrical drum.

8. An image forming method performed in an image forming apparatus comprising a drum, the method comprising:
forming an electrostatic latent image corresponding to print data that is to be printed, on a surface of the drum;
developing the electrostatic latent image so as to generate a developed image;
transferring the developed image onto a printing medium; and
fixing the transferred image to the printing medium,
wherein the forming of the electrostatic latent image is performed by the drum itself.

9. The image forming method of claim 8, wherein in the forming of the electrostatic latent image, the electrostatic latent image is formed by, in consideration of the print data, charging each of a plurality of cells that constitute a circumference of the drum.

10. The image forming method of claim 9, wherein the cells are arranged in a matrix.

11. The image forming method of claim 8, wherein at least a portion of the surface of the drum on which the developed image is located is charged in accordance with the polarity of the developed image, and in this state, the transferring of the developed image onto the printing medium is performed.

12. The image forming method of claim 8, further comprising:
after the transferring of the developed image onto the printing medium, initializing an electrical state of the surface of the drum.

13. The image forming method of claim 8, wherein the forming of the electrostatic latent image is performed at least based on at least one of a printing resolution set for the print data and a size of the printing medium.

14. The image forming method of claim 8, wherein the drum is one of a belt drum and a cylindrical drum.

15. A computer readable recording medium having recorded thereon an image forming method performed in an image forming apparatus comprising a drum, the method comprising:
forming an electrostatic latent image corresponding to print data that is to be printed, on a surface of the drum;
developing the electrostatic latent image so as to generate a developed image;
transferring the developed image onto a printing medium; and
fixing the transferred image to the printing medium,
wherein the forming of the electrostatic latent image is performed by the drum itself.
